(19) United States
(12) Patent Application Publication
(10) Pub. No.: US 2002/0031368 A1
(43) Pub. Date: Mar. 14, 2002

(54) Developing cartridge, process cartridge and electrophotographic image forming apparatus

(76) Inventors: Kazuhiko Kanno, Odawara-shi (JP); Tatsuya Shiratori, Yokohama-shi (JP); Kouji Hashimoto, Shizuoka-ken (JP); Tachio Kawai, Odawara-shi (JP)

Correspondence Address: FITZPATRICK CELLA HARPER & SCINTO, 30 ROCKEFELLER PLAZA, NEW YORK, NY, 10112, US

(21) Appl. No.: 09/899,021

(22) Filed: Jul. 6, 2001

(30) Foreign Application Priority Data
Jul. 7, 2000 (JP) 206942/2000

(51) Int. Cl. G03G 15/08

(52) U.S. Cl. 399/103

(57) ABSTRACT

A process cartridge detachably mountable to a main assembly of an image forming apparatus includes an electrophotographic photosensitive member; developing means for developing an electrostatic latent image formed on the electrophotographic photosensitive member with a developer; a developer container for containing the developer, the developer container having an opening for supplying the developer to the developing means: a sealing member for sealing the opening of the developer container; a winding shaft for winding the sealing member, the sealing member being rotatably supported by the developer container; driving means for applying a driving force to rotate the winding shaft; and drive control means for permitting and preventing transmission of the driving force to the winding shaft, wherein the driving control means permits the transmission in response to insertion of the process cartridge into the main assembly of the image forming apparatus and prevents transmission in response to a predetermined number of rotations of the winding shaft.

### FIELD OF THE INVENTION AND RELATED ART

The present invention relates to a developing cartridge, a process Cartridge and an electrophotographic image forming apparatus to which the process cartridge is mountable. The electrophotographic image forming apparatus forms an image on a recording material through an electrophotographic image formation type process. Examples of the electrophotographic image forming apparatus include an electrophotographic copying machine, electrophotographic printer (a laser beam printer or LED printer mountable), a facsimile machine, a word processor and the like. The process cartridge integrally contains an electrophotographic photosensitive drum, and charging means, developing means or cartridge, in the form of a unit or a cartridge, which Is detachably mountable to a main assembly of an image forming apparatus. The process cartridge may contain the electrophotographic photosensitive drum, and at least one of charging means, developing means and cleaning means, in the form of a cartridge which is detachably mountable to the main assembly of the image forming apparatus. Furthermore, the process cartridge may contain at least the electrophotographic photosensitive drum and the developing means. The present invention is applicable to a process cartridge having developing means of a such a structure.

Heretofore, in an electrophotographic image forming apparatus using the electrophotographic image process, a process cartridge type in which the electrophotographic photosensitive member and process means actable on the electrophotographic photosensitive member are integrally contained in a cartridge, which is detachably mountable to the main assembly of the image forming apparatus. Heretofore, in an electrophotographic image forming apparatus using the electrophotographic image process, a process cartridge type in which the electrophotographic photosensitive member and process means actable on the electrophotographic photosensitive member are integrally contained in a cartridge, which is detachably mountable to the main assembly of the image forming apparatus.

Such a process cartridge contains a photosensitive drum, and developing means is used to apply the developer (toner) to the latent image formed on photosensitive drum. In the developing means, a developing device frame supporting a developing roller for feeding the toner to the photosensitive drum and a toner frame (toner container) accommodating the toner, are coupled with each other. Before the start of use of the process cartridge, the opening provided in the connecting portion between the toner frame and the developing device frame are sealed by a seal member. A process cartridge equipped with an automatic toner seal removing device for automatically unsealing the opening of the toner frame when the process cartridge is mounted to the main assembly of the image forming apparatus, and an image forming apparatus which is capable of driving the automatic toner seal winding device, are known.

The present invention provides a further development.

### SUMMARY OF THE INVENTION

It is a principal object of the present invention to provide a developing cartridge, a process cartridge and an image forming apparatus to which the process cartridge is mountable.

According to an aspect of the present invention, there is provided a process cartridge detachably mountable to a main assembly of an image forming apparatus, comprising: an electrophotographic photosensitive member; developing means for developing an electrostatic latent image formed on the electrophotographic photosensitive member with a developer; a developer container for containing the developer, the developer container having an opening for supplying the developer to the developing means; a sealing member for sealing the opening of the developer container; a winding shaft for winding the sealing member, the sealing member being rotatably supported by the developer container; driving means for applying a driving force to rotate the winding shaft; and drive control means for permitting and preventing transmission of the driving force to the winding shaft, wherein the driving control means permits the transmission in response to insertion of the process cartridge into the main assembly of the image forming apparatus and prevents transmission in response to a predetermined number of rotations of the winding shaft.

According to another aspect of the present invention, there is provided an electrophotographic image forming apparatus for forming an image on a recording material, to which a process cartridge is detachably mountable, the apparatus comprising: a. mounting means for detachably mounting the process cartridge, the process cartridge including: an electrophotographic photosensitive member; developing means for developing an electrostatic latent image formed on the electrophotographic photosensitive member with a developer; a developer container for containing the developer, the developer container having an opening for supplying the developer to the developing means; a sealing member for sealing the opening of the developer container; a winding shaft for winding the sealing member, the sealing member being rotatably supported by the developer container; driving means for applying a driving force to rotate the winding shaft; and drive control means for permitting and preventing transmission of the driving force to the winding shaft, wherein the driving control means permits the transmission in response to insertion of the process cartridge into the main assembly of the image forming apparatus and prevents transmission in response to a predetermined number of rotations of the winding shaft; b. feeding means for feeding the recording material: and c. driving means for driving the driving means of the process cartridge.

According to a further aspect of the present invention, there is provided a process cartridge detachably mountable to a main assembly of an image forming apparatus, comprising: developing means for developing an electrostatic latent image formed on and electrophotographic photosensitive member with a developer; a developer container for containing the developer, the developer container having an opening for supplying the developer to the developing means; a sealing member for sealing the opening of the developer container; a winding shaft for winding the sealing member, the sealing member being rotatably supported by the developer container; driving means for applying a driving force to rotate the winding shaft; and drive control means for permitting and preventing transmission of the driving force to the winding shaft, wherein the driving control means permits the transmission in response to insertion of the developing cartridge into the main assembly of the image forming apparatus and prevents transmission in response to a predetermined number of rotations of the winding shaft.

According to a further aspect of the present invention there is provided an electrophotographic image forming apparatus for forming an image on a recording material, to which a developing cartridge is detachably mountable, comprising: a. mounting means for detachably mounting the process cartridge, the process cartridge including: developing means for developing a latent image formed on an electrophotographic photosensitive member with a developer; a developer container for containing the developer, the developer container having an opening for supplying the developer to the developing means; a sealing member for sealing the opening of the developer container; a winding shaft for winding the sealing member, the sealing member being rotatably supported by the developer container; driving means for applying a driving force to rotate the winding shaft; and drive control means for permitting and preventing transmission of the driving force to the winding shaft, wherein the driving control means permits the transmission in response to insertion of the developing cartridge into the main assembly of the image forming apparatus and prevents transmission in response to a predetermined number of rotations of the winding shaft: b. feeding means for feeding the recording material; and c. driving means for driving the driving means of the process cartridge.

According to the present invention, it is not until the process cartridge is inserted into the image forming apparatus that drive transmission from the driving means to the winding-up shaft is permitted, and therefore, even if driving means is actuated for the purpose of inspection during the assembling of the process cartridge, the seal member is not unintentionally wound up. When the winding-up shaft rotates through a predetermined number of turns, the winding-up shaft is released from the driving, and therefore, the winding-up shaft is not driven after the sealing number is wound up. Thus, It can be avoided that end portion of the seal member flappers with the result of toner scattering and/or different sound or the like. Additionally, the load of the driving source of the main assembly of the image forming apparatus can be reduced.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a longitudinal sectional view of a multi-color electrophotographic image forming apparatus.

FIG. 2 in a front view of a development rotary.

FIG. 3 a front view of a development rotary.

FIG. 4 is a longitudinal sectional view of a developing cartridge.

FIG. 5 is a longitudinal sectional view of the developing cartridge.

FIG. 6 is a perspective view of a developing cartridge.

FIG. 7 is a perspective view of a developing cartridge.

FIG. 8 is a partly exploded perspective view of a developing cartridge.

FIG. 9 is an exploded perspective view of a neighborhood of a developing cartridge.

FIG. 10 is a perspective view of a toner container to which a toner seal member is affixed.

FIG. 11 is a front view of an automatic toner seal removing mechanism.

FIG. 12 is a front view of an automatic toner seal removing mechanism.

FIG. 13 is a side view of an automatic toner seal removing mechanism according to Embodiment 1 of the present invention.

FIG. 14 is a side view of an automatic toner seal removing mechanism according to Embodiment 1 of the present invention.

FIG. 15 is a front view illustrating a function of an automatic toner seal removing mechanism.

FIG. 16 is a front view illustrating a function of an automatic toner seal removing mechanism.

FIG. 17 is a front view illustrating a function of an automatic toner seal removing mechanism.

FIG. 18 is a front view illustrating a function of an automatic toner seal removing mechanism.

FIG. 19 is a side view of an automatic toner seal removing mechanism according to Embodiment 1 of the present invention.

FIG. 20 is a side view of an automatic toner seal removing mechanism according to Embodiment 1 of the present invention.

FIG. 21 is a longitudinal sectional view of a process cartridge according to Embodiments 3 of the present invention.

FIG. 22 is a longitudinal sectional view of an electrophotographic image forming apparatus with which the Embodiment 3 is usable.

FIG. 23 is a longitudinal sectional view of an electrophotographic image forming apparatus with which the Embodiment 3 is usable.

FIG. 24 is a perspective view of an electrophotographic image forming apparatus with which the Embodiment 3 is usable.

FIG. 25 is a perspective view of a process cartridge with which the Embodiment 3 is usable.

### DESCRIPTION OF THE PREFERRED EMBODIMENTS

Next, an embodiment of a development cartridge in accordance with the present invention, and an electrophotographic image forming apparatus which employs such a development cartridge, will be described.

### Embodiment 1

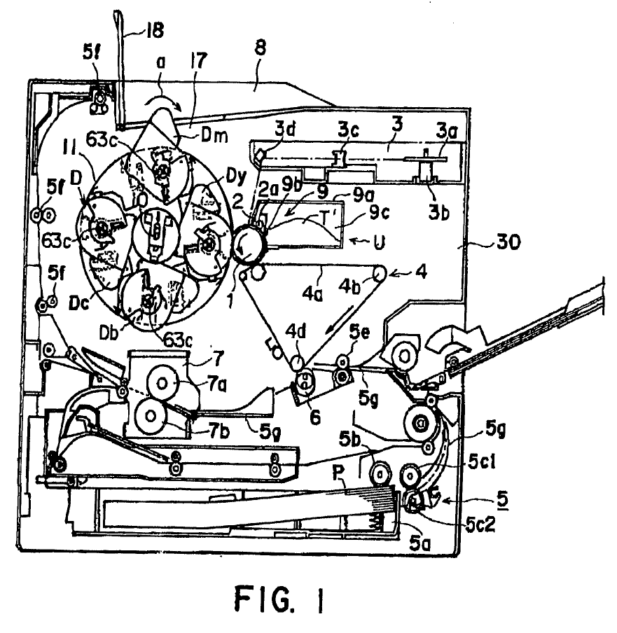

First, referring to FIGS. 1-14, the general structure of an image forming apparatus in accordance with the present invention will be described.

### General Description of Image Forming Apparatus

First, referring to FIG. 1, the general structure of a color image forming apparatus will be described.

FIG. 1 is a vertical sectional view of a laser printer, a form of a color image forming apparatus, for describing the general structure thereof.

The color laser printer comprises: a process cartridge U in which a photosensitive drum 1, which rotates at a constant velocity, is supported; an image forming portion comprising four rotatable development cartridge D; and an intermediary transfer member 4 which holds color images as the color images are developed in the image forming portion and transferred onto the intermediary transfer member 4, and then transfers the color images onto a transfer medium P delivered to the intermediary transfer member 4 by a conveying means 5.

The transfer medium P onto which the color images have been just transferred is conveyed to a fixing portion, in which the color images are fixed to the transfer medium P. Thereafter, the transfer medium P is discharged by a discharge roller 5f into a delivery portion 8 located at the top of the apparatus. The rotatable development cartridges D are structured so that they can be individually mounted into or dismounted from the main assembly 30 of the printers.

Next, the structures of various components and portions of the image forming apparatus will be described detail.

### Process Cartridge

The process cartridge U has a photosensitive drum 1, and a cleaning apparatus, the container portion 9a of which is an integral part of the process cartridge U and doubles as the holder for the photosensitive drum 1. It is removably supported by the printer main assembly 30 so that the process cartridge U which is currently in the printer main assembly 30 can be easily replaced with a new process cartridge in accordance with the service life of the photosensitive drum 1.

The photosensitive drum 1 in this embodiment comprises an aluminum cylinder with a diameter of approximately 50 mm. and an organic photoconductor layer coated on the peripheral surface of the aluminum cylinder. It is rotationally supported by the cleaning apparatus container portion 9a which doubles as the holder for photosensitive drum 1. In the adjacenies of the peripheral surface of the photosensitive drum 1, a cleaning blade 9b for removing the developer (toner) remaining on the peripheral surface of the photosensitive drum 1, and a primary charging means 2 for uniformly charging the peripheral surface of the photosensitive drum 1, are disposed. The photosensitive drum 1 is rotated in the counterclockwise direction, as shown in the drawing, in synchronism with an image forming operation, by transmitting driving force from an unshown motor to one end of the photosensitive drum 1, that is, the end on the rear side of the drawing.

### Charging Means

The charging means 2 in this embodiment is such as charging means that employs a contact charging method, and comprises an electrically conductive roller 2a, which is placed in contact with the photosensitive drum 1. The peripheral surface of the photosensitive drum 1 is uniformly charged by applying voltage to the charge roller 2a placed in contact with the peripheral surface of the photosensitive drum 1.

### Exposing Means

The exposing of the photosensitive drum 1 is carried out by a scanner portion 3. More specifically, as image signals are given to a laser diode, the laser diode emits image light modulated with the image signals, at a polygon mirror 3a.

The polygon mirror 3a is rotated at a high velocity by a scanner motor 3b. While the polygon mirror 3a is rotated at a high velocity, the image light is reflected by the polygon mirror 3a, passed through a focusing lens 3c, deflected by a reflection mirror 3d, and projected onto the peripheral surface of the photosensitive drum 1 which is being rotated at a predetermined constant velocity, selectively exposing the peripheral surface of the photosensitive drum 1. As a result, an electrostatic latent image is formed on the peripheral surface of the photosensitive drum 1.

### Developing Means

The developing means is provided with four development cartridge Dy, Dm, Do and Db, which are capable of visualizing, that is, developing, an electrostatic latent image in yellow, magenta, cyan, and black colors, correspondingly.

Referring to FIGS. 1-3, each of the four development cartridges D is removably held by a rotary unit 11 enabled to rotate about a shaft 10. In an image forming operation, each development cartridge D is moved by the rotation of rotary unit 11 to a predetermined position, at which the development roller, which will be described later, opposes the photosensitive drum 1, holding a microscopic gap (approximately 300 μm) from the photosensitive drum 1, and forms a visible image which reflects the electrostatic latent image, on the photosensitive drum 1.

In a color image forming operation, each time the intermediary transfer member 4 rotates once, the rotary unit 11 also rotates once, moving the yellow development cartridge Dy, magenta development cartridge Dm, cyan development cartridge Dc, and black development cartridge Db, in this order, to the above described predetermined position to carry out development processes.

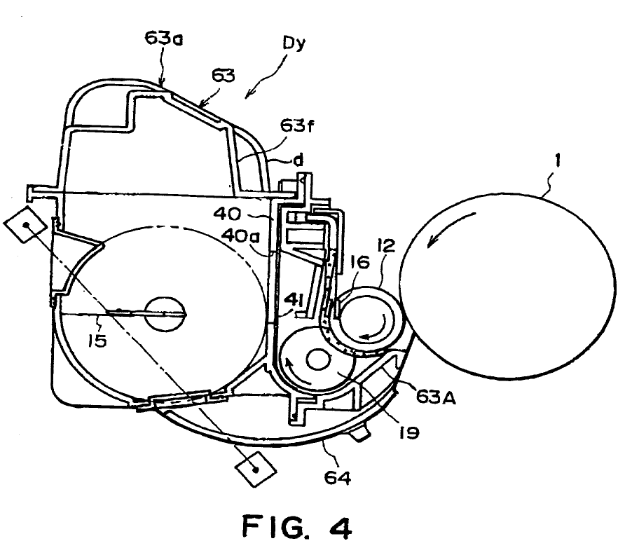

FIG. 4 shows the yellow development cartridge Dy which is standing still, being positioned to oppose the process cartridge U. In the development cartridge Dy, the toner in the toner container 63a is sent to a toner supplying roller 19 by a toner sending mechanism 15. Then, the toner is coated in a thin layer on the peripheral surface of the development roller 12, which is rotating in the clockwise direction indicated in the drawing, by the toner supplying roller 19 which is rotating in the clockwise direction indicated also in the drawing, and a development blade 16 which is kept pressed upon the peripheral surface of the development roller 12. While the toner is coated, the toner is given electrical charge (triboelectrical charge).

Then, development bias is applied to the development roller 12, which is opposing the photosensitive drum 1 on which a latent image has been formed, to form a toner image which reflects the latent image on the photosensitive drum 1. The same toner image forming process as the one described above with reference to the yellow development cartridge Dy is also carried out in the magenta development cartridge Dm, cyan development cartridge Dn, and black development cartridge Db, which are the same in mechanism as the yellow development cartridge Dy described above.

The image forming apparatus main assembly 30 in structured so that, as each development cartridge D is rotated to the development position, its development roller 12 is connected to a high voltage power source and a mechanical driving means (unshown), and development bias is applied to the development roller 12. This process is carried out one after another for all development cartridges in the aforementioned order.

The yellow, magenta, and cyan development cartridges Dy, Dm and Dc, shown in FIG. 4, are the same in structure; they each have the toner supplying roller 19, which is rotationally supported by the developing means holding portion 63A of the cartridge frame 63. The peripheral surface of the toner supplying roller 19 moves in the direction opposite to the direction in which the peripheral surface of the development roller 12 moves.

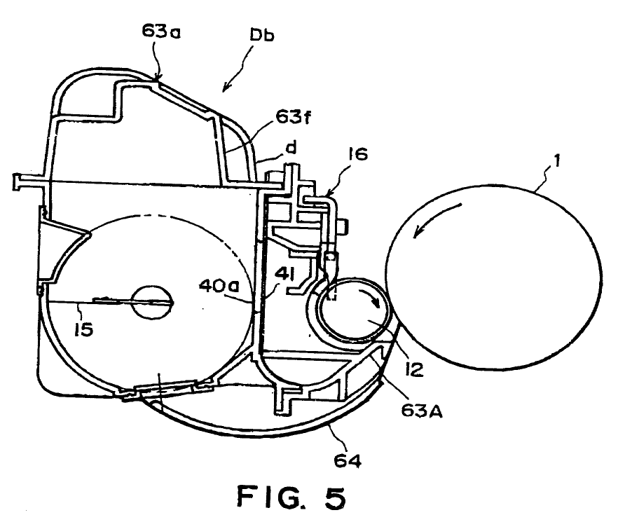

In comparison, the black development cartridge Db sown in FIG. 5 does not have the toner supplying roller 19; toner is adhered to the development roller 12 by magnetic force, or adheres to the development roller 12 due its own adhesive force, and the thickness of the toner layer on the development roller 12 is required by the development blade 16 placed in contact with the peripheral surface of the development roller 12. As the toner layer on the peripheral surface of the development roller 12 is regulated in thickness, the toner is given triboelectrical charge.

### Intermediary Transfer Means

The intermediary transfer member 4 is a member onto which a toner image is temporarily transferred. More specifically, each time one full-color image is formed, four toner images different in color (Y, M, C and Bk color images), or four visible images different in color, formed on the photosensitive drum 1 by the four developing means, one for one, are transferred in layers onto the intermediary transfer member 4, which is being rotated in the clockwise direction indicated in the drawing, at the same peripheral velocity as that of the photosensitive drum 1. The intermediary transfer member 4 having received a plurality toner images, in layers, transfers, all at once in layers, the color toner images thereon onto the transfer medium P by conveying the transfer medium P by sandwiching the transfer medium P between itself and the transfer roller 6 to which voltage is being applied. In the intermediary transfer member 4 in this embodiment, an endless transfer belt 4e formed of dielectric material sheet is stretched around a plurality of rollers, and is rotated by the driving roller in the direction indicated by an arrow.

### Cleaning Means

The cleaning means 9 in a means for removing, from the photosensitive drum 1, the toner remaining on the photosensitive drum 1 after the toner image, or a visual image, formed on the photosensitive drum 1 by the developing means is transferred by the intermediary transfer member 4. The toner removed from the photosensitive drum 1, or residual toner T is collected in a residual toner container 9a. The amount of the residual toner in not large enough to fill up the residual toner container 9a before the service life of the photosensitive drum 1 expires. Thus, the residual toner container 9a, which is a part of the process cartridge U, is replaced with a new one, at the same time as the process cartridge U is replaced with a new one due to the expiration of the service life of the photosensitive drum 1.

### Sheet Feeding Portion

The conveying means 5, the most upstream portion of which in terms of the recording medium conveyance direction is a sheet feeder portion, is a means for conveying the transfer medium P to the image forming portion. It essentially comprises: a cassette 5a in which a plurality of transfer media P are stored; a sheet feeder roller 5b, a combination of a sheet feeder roller 5c1 and a retarder roller for preventing the recording medium P from being fed by two or more, a sheet guide 5g, and a registration roller 5e.

In an image forming operation, the sheet feeder roller 5b is rotationally driven in synchronism with the image forming operation to feed the recording media P within the cassette 5a into the apparatus main assembly, one by one Then, each recording medium P is conveyed, while being guided by guiding plates (unshown), to the registration roller 5e past the sheet feeder roller 5c1.

During the image forming operation, the registration roller 5e carries out, in a predetermined sequence, a process in which it remains still to keep the transfer medium P on standby, and a process in which it rotates to release and convey the recording medium P toward the intermediary transfer member 4, so that the released transfer medium P aligns with an image during the following process, that is, the transfer process.

### Transferring Portion

The transferring portion comprises the transfer roller 6, which can be moved in the direction to be pressed upon the transfer belt 4a, or in the direction to be separated therefrom. The transfer roller 6 comprises a metallic shaft, and a layer of foamed elastic material wrapped around the peripheral surface of the metallic shaft. The electrical resistance of the foamed elastic material layer is in the medium range. It is movable in the vertical direction of the drawing, and is connected to a mechanical driving means.

While the above mentioned four toner images are formed on the intermediary transfer member 4, that is, while the intermediary transfer member 4 rotates a plural number of times, the transfer roller 6 is kept at the bottom position outlined by a bold line in the drawing, being kept away from the intermediary transfer member 4, to prevent the transfer roller 6 from disturbing the images while they are being formed.

Then, as the formation of the four toner images different in color on the intermediary transfer member 4 ends, the transfer roller 6 is moved to the top position outlined by a fine line in the drawing, by an unshown cam, in synchronism with the timing with which the multi-color image, or the combination of the four color toner images, is to be transferred onto the transfer medium P. In other words, the transfer roller 6 is pressed upon the intermediary transfer member 4, with the interposition of the transfer medium P between the intermediary transfer or member 4 and transfer roller 6. At the same time as the transfer roller 6 is pressed upon the intermediary transfer member 4, bias begins to be applied to the transfer roller 6. As a result, the toner images on the intermediary transfer member 4 are transferred onto the transfer medium P.

The intermediary transfer member 4 and transfer roller 6 are driven independently from each other. Therefore, as the transfer process progresses, the transfer medium P being sandwiched between the two rollers is conveyed leftward of the drawing at a predetermined velocity to the fixing portion 7, in which the following process is carried out.

### Fixing Portion

The fixing portion 7 is a portion for fixing the toner images, which have been formed on the photosensitive drum 1 by developing means and have been transferred onto the transfer medium P, to the transfer medium P. It comprises: a fixing roller 7a for applying heat to the transfer medium P, end a pressure roller 7b for pressing the transfer medium P upon the fixing roller 7a. Both rollers 7a and 7b are hollow and contain a heater. They are rotationally driven and convey together the transfer medium P.

More specifically, as the transfer medium P, which is holding the toner images, is conveyed by the fixing roller 7a and pressure roller 7b, heat and pressured is applied to the recording medium P and toner images thereon. As a result, the toner images are fixed to the transfer medium P.

### Mounting of Development Cartridge into Image Forming Apparatus Main Assembly

Next, how the development cartridge is mounted will be described.

First, an unshown button of the printer main assembly 30 is pressed. As the button is pressed, the rotary unit 11 rotates until a specific development cartridge mounting slot of the rotary unit 11, the color designation of which matches the color of the development cartridge D the user wished to mount, comes to a predetermined position at which the development cartridge D can be mounted

Next, tho user opens the cover 18 of the development cartridge mounting opening 17 located at a predetermined portion of the printer main assembly 30. Normally the opening 17 is kept covered with the cover 18.

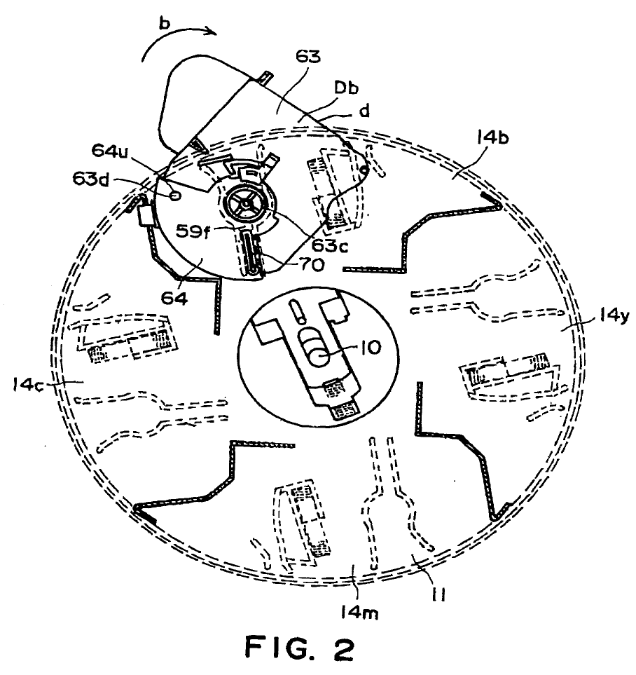

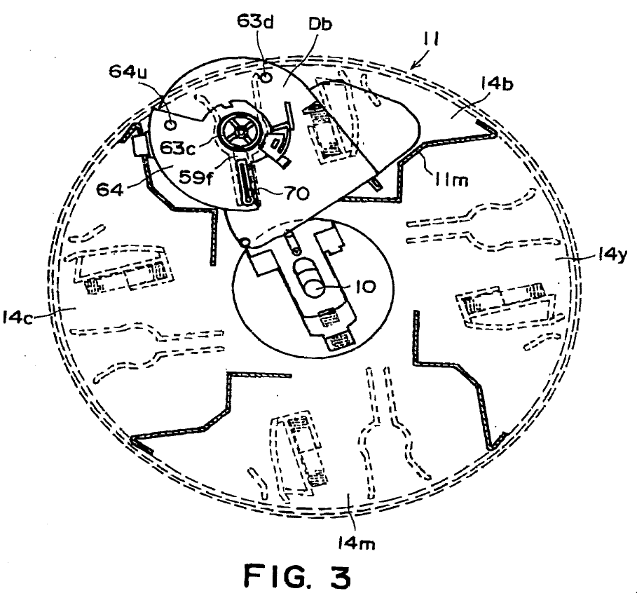

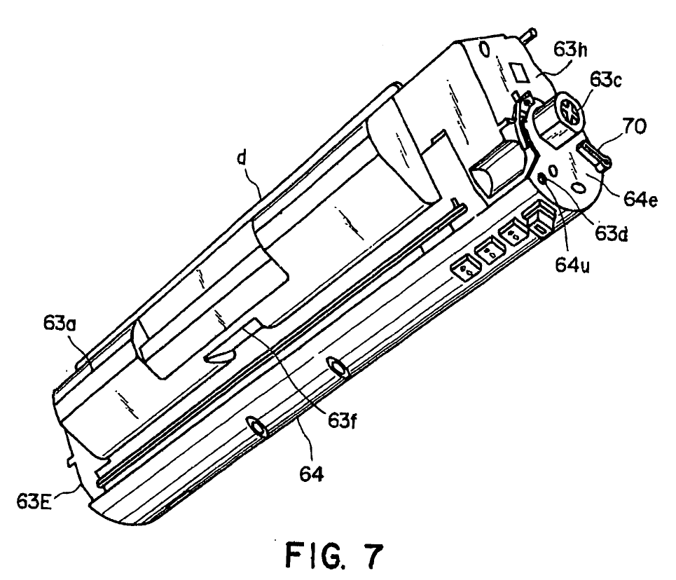

Then, the guide ribs 70 on the side walls of the shutter 64 (which will be described later in detail) of the development cartridge D identical in color to the color designation of the development cartridge mounting slot 14 which is at this point aligning with the opening 17, is rested on the cartridge guides 59f (FIGS. 2 and 3) on the internal walls of the rotary unit 11 of the apparatus main assembly 30, and the development cartridge D is pushed inward (FIG. 2). At this point, the operator grasps by hand the handhold recess 63f (FIG. 7) integral with the toner container portion 63a of the development cartridge D, and turns the development cartridge D in the direction indicated by arrow mark (1) in FIG. 1. As the development cartridge D is turned, only the actual development unit D rotates, with the shutter remaining held to the rotary unit 11. As a result, the development roller 12 is exposed, to be ready for development (FIG. 5). The cartridge guide 59f and the relevant guides are provided at each quarter portion of the circumference of the rotary unit 11 (cartridge mounting portions 14y, 14m, 14c, 14b).

### Shutter

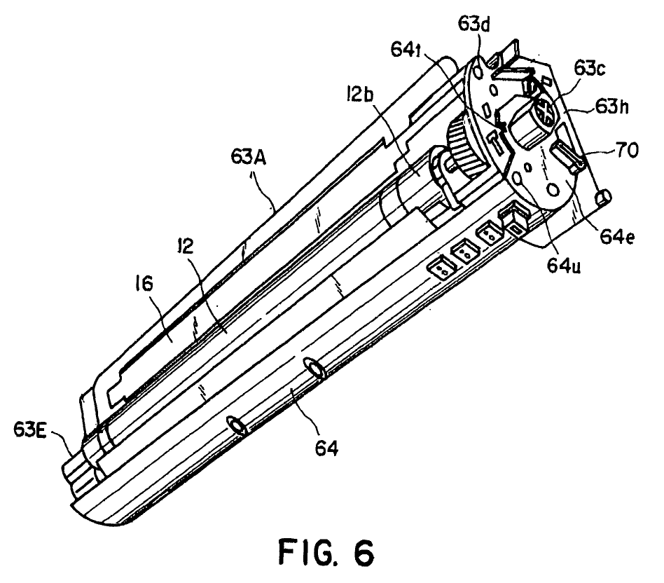

Next, referring to FIGS. 6-8, the shutter 64 of the development cartridge D will be described.

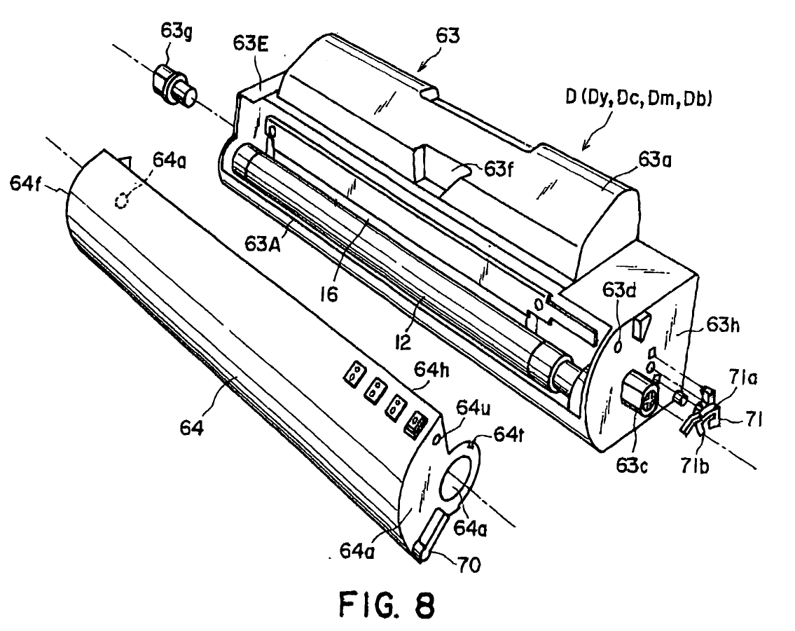

Referring to FIG. 8, both side walls 64e and 64f of the shutter 64 in terms of the lengthwise direction of the shutter 64 are provided with a round hole 64a, into which the projections 63c and 63g projecting, one for one, from the side walls of the developing means holding frame 63 in terms of its lengthwise direction, are fitted to rotationally support the shutter 64 by the cartridge frame 63.

Next, referring to FIGS. 6 and 7, the shutter 64 is enabled to take the covering position at which it covers the development roller 12, or the retracted position at which it exposes the development roller 12. When the development cartridge D is out of the printer main assembly 30, the shutter 64 remains closed. Therefore, when the development cartridge D has never been used, it does not occur that dust and the like adheres to the development roller 12, or the development roller 12 is damaged.

The cartridge frame 63 is provided with a locking member 71 for keeping the shutter 64 locked in the closed state in the adjacencies of the projection 63c. The locking member 71 comprises an elastic arm portion 71a and an engaging portion 71b. On the other hand, one of the side walls 64e of the shutter 64, on the same side as the locking member 71, is provided with a recess 64t, which is located at a predetermined position, and with which the engaging portion 71b engages. Thus, when the shutter 64 is in the closed state, the engaging portion 71b remains engaged in the recess 64t, keeping the shutter 64 locked in the closed state to prevent the shutter 64 from accidentally opening.

As the development cartridge D is inserted into the printer main assembly 30, the lock is automatically released to allow the shutter 64 to be opened.

Further, the side walls 64e of the shutter 64 are provided with a round hole 64u, and the side walls 63h of the development unit are provided with a semispherical projection 63d, the position of which corresponds to that of the round hole 64u. Thus, when the shutter 64 is in the closed state, the semispherical projections 63d remain engaged in the corresponding round holes 64u, and therefore, even after the shutter 64 is unlocked as described above, the positional relationship between the shutter 64 and development cartridge D in terms of the rotational direction of the shutter 64 does not become unstable.

### Automatic Toner Seal Member Opening Apparatus

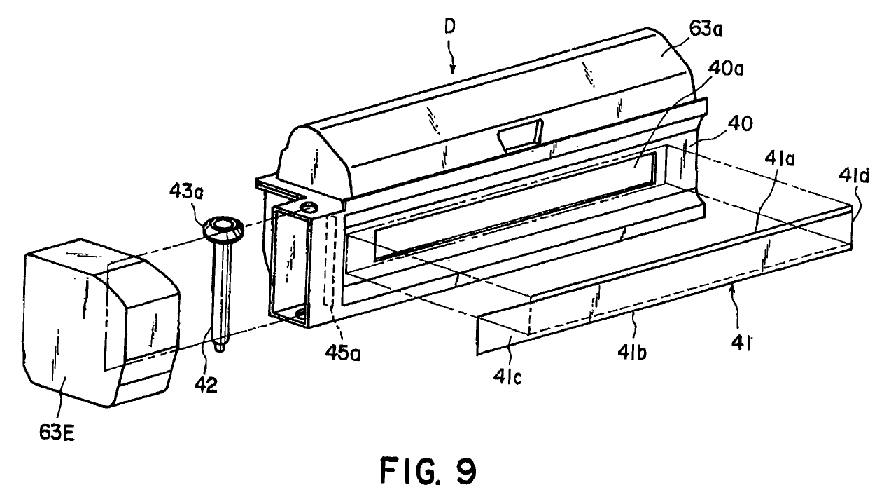

Next, referring to FIGS. 9-12, the structure of an embodiment of an automatic mechanism for opening a toner seal, in accordance with the present invention, will be described in detail.

The drive control means permits drive transmission from the driving means to the common seal winding shaft by the insertion of the developing cartridge D into the main assembly 30 of the image forming apparatus. Then, when the winding shaft rotates through a predetermined number of turns, the drive transmission is stopped.

When the process cartridge is inserted into the main assembly, a slide gear 65 is abutted to a projection 30b and slides through a predetermined distance to be brought into engagement with a gear 12d, by which the winding shaft can receive the driving force through the swingable unit 66 and the gear 43b.

Then, the winding shaft rotates through a predetermined number of turns, so that the toner sealing member is wound up, the cam portion 67c having a Geneva mechanism 67 releases engagement between the gear 66b2 and 43b2, so that the drive transmission to the winding shaft is released.

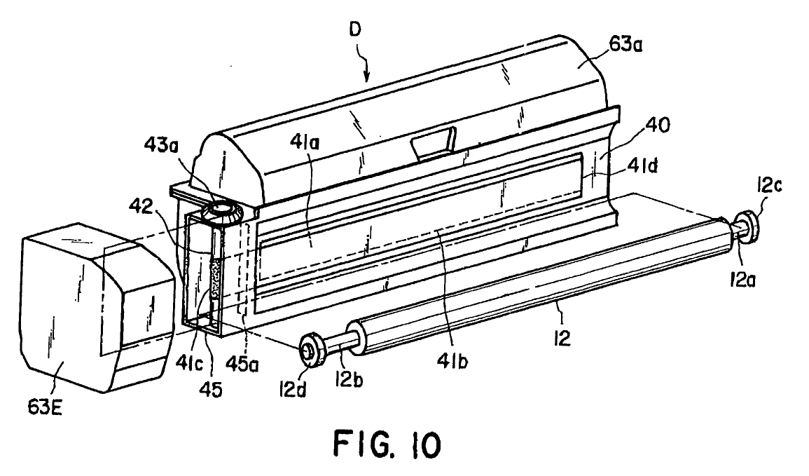

The frame of the development cartridge D comprises a toner container portion 63a in which toner is stored, and a developing means holding portion 63A, as shown in FIGS. 4, 9 and 10. The wall 40 of the toner container portion 63a, on the developing means holding portion 63A side, is provided with a toner supplying opening 40a, along the fringe of which the toner sealing member 41 is peelably pasted with the use of thermal welding or the like, to keep the toner sealed within the toner container portion 63a to prevent the toner from scattering while the development cartridge D is delivered to a user, that is, during the transportation of the development cartridge D. In this embodiment, the toner sealing member 41 is formed of flexible sheet. FIGS. 9 and 10 show the structure of toner sealing means in accordance with the present invention. The length of the toner sealing member 41 is more than twice the measurement of the aforementioned opening 40a in terms of the lengthwise direction of the opening 40a. The toner sealing member 41 comprises: a sealing portion 41a peelably attached to the fringe of the opening 40a in a manner to seal the opening 40a by such a means as thermal welding, and a doubling portion 41b which is continuous with one end of the sealing portion 41b. The doubling portion 41b is folded back at a double back point 41b in the adjacencies of the end of the opening 41a, in terms of its length direction, at which the two portions are continuous. It is doubled back on the sealing portion 41a, to the other end of the opening 41a. The end portion 41c of the doubling portion 41b, which is not continuous with the sealing portion 41a, is fixed to a winding shaft 42 with the use of adhesive or the like. The winding shaft 42 is enabled to be rotated about a rotational axis perpendicular to the axial line of the development roller 12, being rotationally supported by the toner container portion 63a. One end of the winding shaft 42 is provided with a first bevel gear 43a for rotating the winding shaft 42, which is an integral part of the winding shaft 42.

The flange 12b of the development roller 12, on the winding shaft 42 side, is provided with the development roller gear B12d, which is firmly fixed thereto, and is used for transmitting the driving force inputted from the printer main assembly, which will be described later, to the winding shaft 42. The development roller gear B12d and winding shaft 42 are connected to each other through a gear train provided on the side holder 63E, which will be described later.

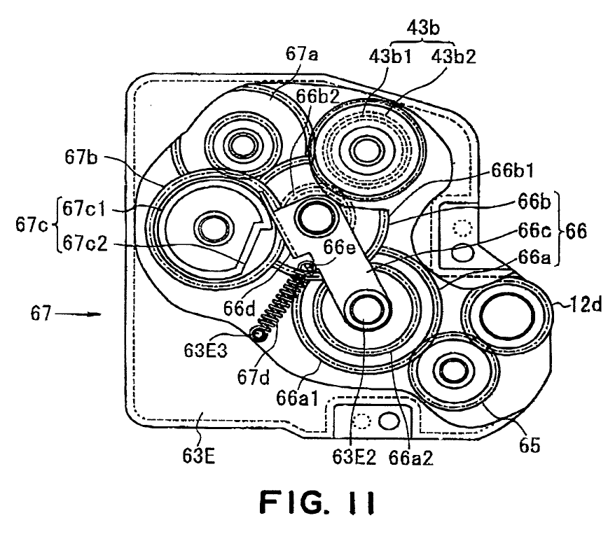

As shown in FIG. 11, the swing gear unit 66 includes swing gears 66a and 66b. The swing gears A66a, B66b are two-speed gear, and a large gear 66a1 of the swing gear A66a is in meshing engagement with an idler gear 65. The small gear 66a2 of the swing gear A66a is in meshing engagement with the swing gear B66a. The small gear 66a2 of the swing gear B66a and the large gear 66b1 of the swing gear B66a are in meshing engagement with each other. The small gear 66b2 of the swing gear B66a is in meshing engagement with a spur gear portion 63b2 of the second bevel gear.

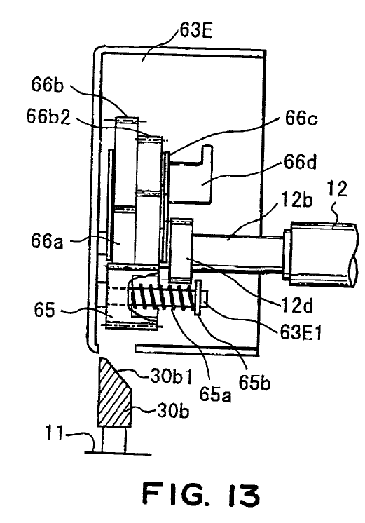

FIG. 11 is an arrangement of a gear train provided on a side holder 63E. Rotatably mounted to the side holder 63E are an idler gear 65 meshed with the developing roller gear B12d, a swing gear unit 66 and a second bevel gear 43b meshed with the first bevel gear 42a integrally mounted to the winding-up shaft 42, which constitute a gear train. As shown in FIG. 13, the idler gear 65 is urged slidably in a longitudinally outward direction or the developing cartridge D by an input spring 65a. The idler gear 65 is rotatably supported by a fixed shaft 63E1 extended out of an inner wall or the side holder 65E in parallelism with the developing roller 12. The input spring 65a is inserted into the fixed shaft 63E1 and is compressed between the idler gear 65 and a stopping ring 65b. The stopping ring 65b is engaged in a circumferential group formed in the fixed shaft 63E1. The input spring 65a is a compression coil spring. In the state, the idler gear 65 is in meshing engagement only with the swing gear A66a of the swing gear unit 66, and is not in meshing engagement with the developing roller gear B12d. However, when it is slid through a predetermined distance in a longitudinally inward direction by an external force upon insertion into the main assembly of the image forming apparatus, as will be described hereinafter, the idler gear 65 is brought into meshing engagement with both of the swing gear unit 66 and the developing roller gear B12d, by which the driving force can be transmitted from the main assembly 30 of the apparatus to the winding-up shaft 42. The second bevel gear 43b is a stepped gear comprising a bevel gear 43b1 for engagement with the first bevel gear 43a and a spur gear portion 43b2. Here, the spur gear 43b2 is engaged with a small gear 66b2 of the swing gear B66a. The swing gear unit 66 comprises a swing gear A66a, a swing gear B66b and a connection plate 66c connecting the two gears with each other. The connection plate 66c is swingable about a supporting shaft 63E2 of the swing gear A66a which is engageable with the idler gear 65. The swing gear portion B66b is rotatably mounted to the end portion of a connection plate 66c and is swingable with the connection plate 66c.

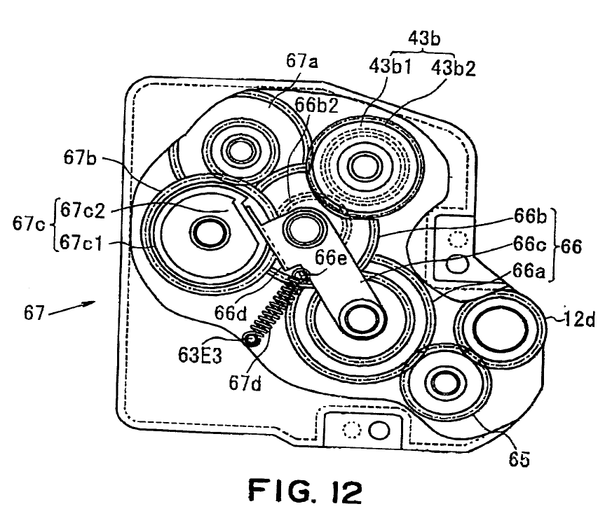

The position of the swingable swing gear unit 66 is selectively controlled by a drive control mechanism 67. The drive control mechanism 67 comprises an intermittent gear A67a for receiving a driving force from the spur gear portion 43b2 of the second bevel gear 43b, and an intermittent gear B67b intermittently rotatable by engagement with the intermittent gear A67a, ad they are rotatably supported on the side holder 63E. The intermittent gear B67b is provided with a holding surface 67c1 and a cam portion 67c which are integral with each other. The holding surface 67c1 assures the position for meshing engagement between the small gear 66b2 of the swing gear B66b and the spur gear portion 43b2 of the second bevel gear 43b, that is, the distance between the centers of the swing gear B66b and the second bevel gear 43b, as shown in the FIG. 11. The cam portion 67c is a blocking surface 67c2 for disengaging them from each other by increasing the distance between the centers of the swing gear B66b and the second bevel gear 43b, as shown in FIG. 12. The cam portion 67c is press-contacted by a lever 66d integrally extended from the connection plate 66c of the swing gear unit 66 by the function of the spring 67d. Therefore, the position of the swing gear B66b is controlled by the cam profile of the cam portion 67c. The spring 67d is a tension coil springs and is hooked at one end on a spring hook 66e provided on the connection plate 66c, and is hooked at the other end on a spring hook 63E3 provided on the side holder 63E.

In this embodiment, as shown in FIG. 10, the winding-up shaft 42 is covered with a winding-up shaft cover 45 which is integral with the toner container 63a or integrated by welding or the like. The winding-up shaft cover 45 is provided with a winding-up opening 45a through which the toner seal member 41 is penetrated, and the folded back end portion 41c of the toner seal member 41 is fixed on the winding-up shaft 42 through the opening 45a.

Referring to FIGS. 11-13, the description will be made as to the operation when the developing cartridge D is mounted to the main assembly 30 of the image forming apparatus.

FIG. 11 shows a state before the developing cartridge D is mounted to the main assembly 30 of the image forming apparatus. In the state, the lever 66d is contacted to the holding surface 67c1 which is an arcuate surface having a center which is the rotational center of the cam portion 67c so that connection plate 66c is urged rightward against the spring force of the spring 67d. Therefore, the small gear 66b2 is in meshing engagement with the spur gear portion 43b2 of the second bevel gear 43b, so that driving force can be transmitted to the winding-up shaft 42. However, the idler gear 65 is urged by the input spring 65a, and therefore, the idler gear 65 is out of meshing engagement with the developing roller gear B12d, as shown in FIG. 13. Therefore, even if the driving force is applied to the developing cartridge D, it is not transmitted to the winding-up shaft 42. For this reason, even if the developing cartridge D is driven for the purpose of initial torque measurement or inspection such as surface damage check of the developing roller 12 after the developing cartridge D is assembled up, the idler gear 65 is not rotated although the developing roller 12 rotates. Accordingly, it can be avoided that toner seal member 41 is wound up unintentionally.

### [Automatic Removal of the Toner Seal Member]

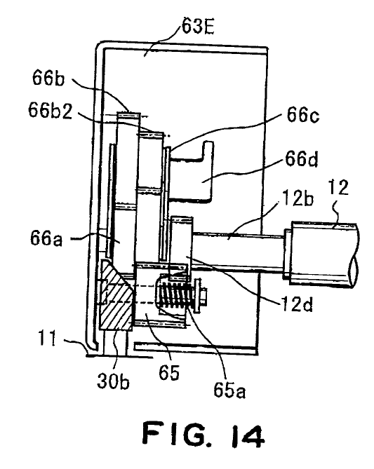

When the developing cartridge D is mounted to the main assembly 30 of the image forming apparatus in place, the developing cartridge D is moved to a predetermined position. Then, as shown in FIGS. 13 and 14, a projection 30b provided in the rotary unit 11 in the main assembly 30 of the image forming apparatus causes the idler gear 65 in the longitudinally inward direction through a predetermined distance. This is effected by abutment of the inclined surface cam portion 30b1 of the projection 30b to a corner of the idler gear 65. By this, the idler gear 65 is brought into meshing engagement with the swing gear A66a and also with the developing roller gear B12d, as shown in FIG. 14, by which the driving force becomes transmittable from the main assembly 30 of the image forming apparatus. Simultaneously, the driving force is transmitted from a driving gear (unshown) of the main assembly 30 of the image forming apparatus to a driven input gear (unshown) provided at an end surface of the toner container 63a which is opposite from the end at which the winding-up shaft 42 is provided. The driven input gear is in meshing engagement with the developing roller gear A12c mounted to a flange 12a at the end opposite from the end having the winding-up shaft 42, so that developing roller 12 is rotated thereby. In this manner, the developing roller gear B12d fixed on the flange 12b which is in turn fixed on the developing roller 12, is rotated. Thus, the driving force is transmitted from the developing roller gear B12d to the winding-up shaft 42 through the gear train, more particularly through the idler gear 65, the swing gear A66a, the swing gear B66b, the second bevel gear 43b and first bevel gear 43a.

The toner seal member 41 which seals the opening 40a as shown in FIG. 10 is gradually wound up on the winding-up shaft 42. When the toner seal member 41 is completely wound up by the winding-up shaft 42, the toner is supplied to the developing roller 12 through the opening 40a.

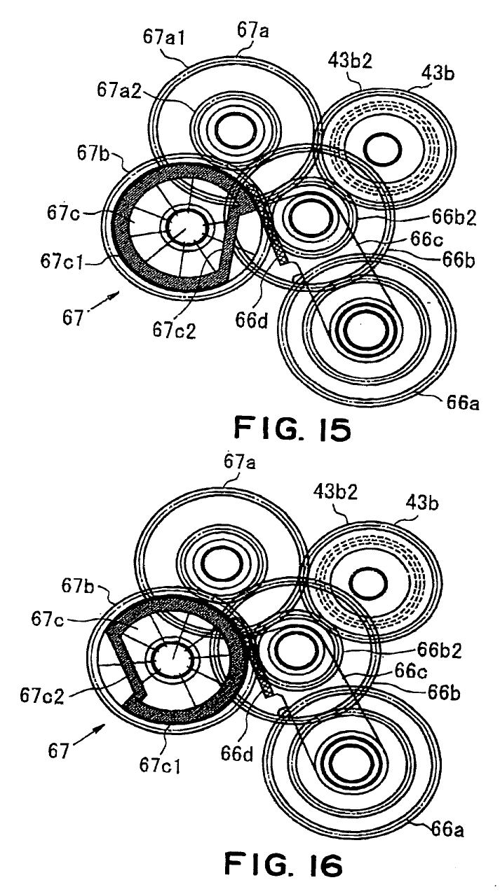

Referring to FIGS. 15-18, the description will be made as to the stop of driving of the winding-up shaft 42 of the drive control mechanism 67. As described in the foregoing, before the developing cartridge D is mounted to the main assembly 30 of the image forming apparatus, the lever 66d integrally extended from the connection plate 66c of the swing gear unit 66 is contacted to the holding surface 67c1 of the cam portion 67c of the intermittent gear B67b.

Therefore, the small gear 66b2 of the swing gear B66b is in meshing engagement with the spur gear portion 43b2 of the second bevel gear 43b (FIG. 15). When the driving force In transmitted from the driving gear of the main assembly 30 of the image forming apparatus through the developing roller gear A12c and so on, the intermittent gear A67a is rotated by the meshing engagement between the small gear 66b2 of the swing gear B66b and the large gear 67a1 of the intermittent gear A67a. The intermittent gear A67a rotates the intermittent gear B67b. Here, the intermittent gear A67a has an integral driving wheel 67a2 of a Geneva ear mechanism, and the intermittent gear B67b is a driven wheel of the Geneva ear mechanism. In the Figure, it is indicated in the form of a gear for simplicity. The intermittent gear B67b is engaged by one tooth with one rotation of the intermittent gear A67a to effect intermittent motion through a predetermined rotational angle.

Thus, when the intermittent gear B67b has n teeth, the intermittent gear B67b rotates through one full turn upon n rotations of the intermittent gear A67a.

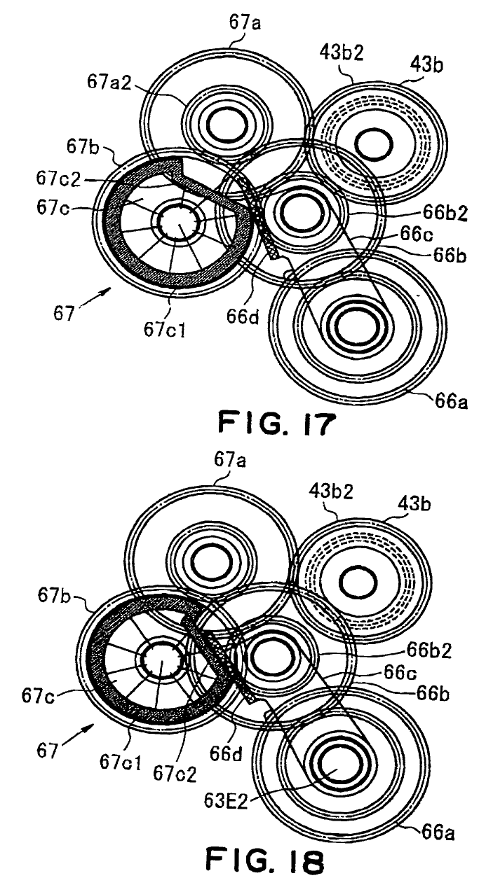

The speed of the intermittent gear B67b is sufficiently reduced relative to the speed of the winding-up shaft 42 so that engagement of the swing gear unit 66 is maintained by the holding surface 67c1 of the cam portion 67c of the intermittent gear B67b, and therefore, the rotational drive for the winding-up shaft 42 is maintained (FIGS. 16-17) before the toner seal member 41 is wound up. As shown in FIG. 17, the intermittent gear B67b temporarily stop while maintaining the contact at the holding surface 67c1, adjacent the boundary between the holding surface 67c1 and the blocking surface 67c2. When the winding-up shaft 42 rotates through such an extent that toner seal member 41 is sufficiently wound up, the driving wheel 67a2 of the Geneva gear mechanism rotates the intermittent gear B67b, and the blocking surface 67c2 is faced to the lever 66d as shown in FIG. 18. The lever 66d is attracted by the spring force of the spring 67d by which the connection plate 66c is rotated in the counterclockwise direction about the supporting shaft 63E2. By this, the swing gear B66b swings to a position where the engagement between the second bevel gear 43b and the spur gear portion 43b2 are released, so the driving of the second bevel gear 43b to the upstream side is stopped, that is, the winding-up shaft 42, the intermittent gear A67a and the intermittent gear B67b are no longer driven (FIG. 18). When the driving to the intermittent gear B67b is stopped, the engagement between the swing gear B66b and spur gear portion 43b2 of the second bevel gear 43b is maintained disengaged, and therefore, the winding-up shaft 42 is not driven again. Therefore, after the toner seal member 41 is wound up, the winding-up shaft 42 is not driven more than necessary, and therefore, the possible toner scattering, the noise or the like due to the flappering of the toner seal member 41 can be prevented, and in addition, the load of the driving motor of the main assembly of the image forming apparatus can be saved after the completion of the winding-up operation of the toner seal member 41.

In this embodiment, the drive transmission and the driving direction change for the winding-up shaft 42 is effected by means of the bevel gear. However, the present invention is not limited to this example, and they may be effected by means of a warm gear or the like.

In this embodiment, the process cartridge and the developing cartridge are detachably mountable, respectively. However, the present invention is applicable to a process cartridge containing as a unit developing means and a photosensitive drum, and is detachably mountable to the main assembly of the image forming apparatus, and also in applicable to a toner supply container alone.

In the foregoing, the Geneva gear mechanism in provided between the intermittent gears A67a B67b, but another intermittent gear mechanism is usable. If such a cam profile is used that when the lever 66d is disengaged from the holding surface 67c1 of the cam portion 67c, the lever 66d quickly displaces to the cam lift 0 position, normal gear rather than the intermittent gear may be used with a high reduction ratio.

### Embodiment 2

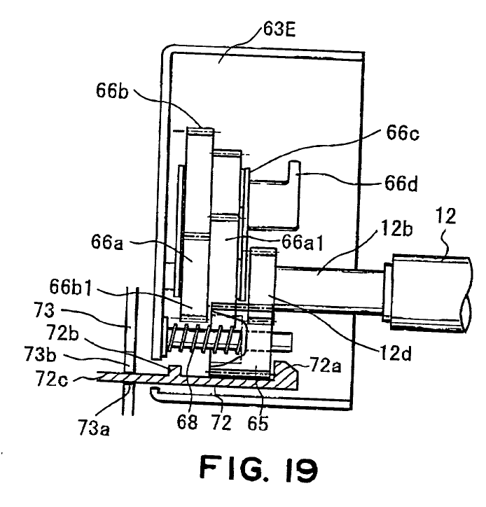

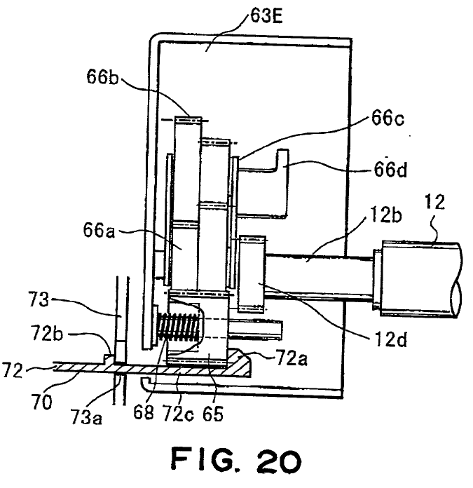

Referring to FIG. 19, the description will be made as to Embodiment 2.

The same, reference numerals as seen the first embodiment are assigned to the elements having the corresponding functions, and the detailed description thereof are limited for simplicity. The.

In the foregoing embodiment, by the movement of the developing cartridge D to the predetermined position who when the developing cartridge D is mounted to tho main assembly 30 of the image forming apparatus, the projection 30b provided in the main assembly 30 of the image forming apparatus causes the idler gear 65 to slide through a predetermined distance, which brings in the idler gear 65 into meshing engagement with the swing gear A66a and the developing roller gear B12d to establish the driving force transmittable state for the winding-up shaft 42.

In Embodiment 2, the driving force is transmittable to the winding-up shaft 42 during normal use, and the driving is not permitted during the inspection in the process of assembling the developing cartridge D.

FIG. 19 FIG. 19 shows the state before the developing cartridge D is mounted to the main assembly 30 of the image forming apparatus, in which the swing gear B66b is in meshing engagement with the spur gear portion 43b2 of the second bevel gear 43b, and the idler gear 65 is urged by the spring 68 to a position for engagement with the large gear 66a1 of the swing gear A66a and the developing roller gear B12d. Therefore, with the state, the driving force can be transmitted to the winding-up shaft 42. In the normal use, when the driving force is supplied from the driving gear 30a when the developing cartridge D having the structure described above is mounted in place in the main assembly 30 of the image forming apparatus, the winding-up shaft 42 is rotated through the gear train, so that toner seal member is wound up.

On the other hand, in the inspecting operation in the plant, when the driving force is applied to the developing cartridge D, a claw 72 of an inspection tool causes the idler gear 65 against the spring 68 in the longitudinally outward direction through a predetermined distance when the developing cartridge D is mounted. By this, the idler gear 65 and the developing roller gear B12d are disengaged from each other. The claw 72 has a round shaft portion 72c, which is provided with a claw portion 72a contactable to a side of the idler gear 65, a locking projection 72b and a shaft portion 70c which is rotatable within a limit relative to the hole 73a.

When the developing cartridge D is set on a step inspecting apparatus 73, the claw 72 is inserted into the hole 73a as shown in FIG. 19. The hole 73b is provided with a cut-away portion 73b (in the radially outward direction) for permitting the claw portion 72a and the locking projection 72b to pass. The thicknesses of the claw portion 72a and the locking projection 12b are smaller than the diameter of the shaft portion 72c. The claw 72 this movement leftwardly against the spring force of the spring 68 to cause the locking projection 72b to pass the cut-away portion 73b at the edge of the hole 71a, and then the shaft portion 72c is rotated slightly to place the locking projection 72b out of alignment with the cut-away portion 73b. By doing so, the idler gear 65 is brought out of engagement with the developing roller gear B12d, and the disengaged state is maintained.

Accordingly, even if the driving force is applied to the developing cartridge D, the driving force is not transmitted to the winding-up shaft 42. In this manner, the driving force is applied to the developing cartridge D for the purpose of inspecting operation for initial torque measurement or for surface damage check of the developing roller 12, the toner seal member 41 is not unintentionally wound up.

### Embodiment 3

The description will be made as to Embodiment 3.

First, the general arrangements of the image forming apparatus and the process cartridge, and then an automatic seal removing device, will be described.

### General Arrangement

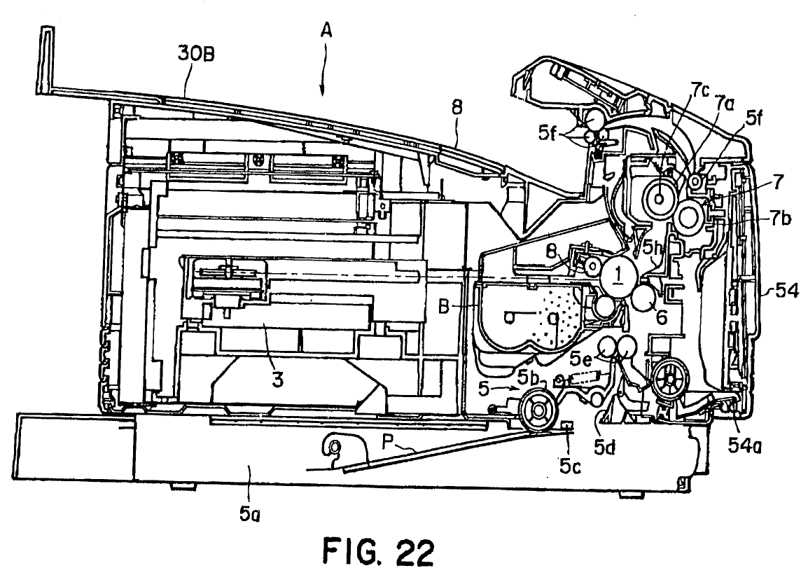

As shown in FIG. 22, in the electrophotographic image forming apparatus (laser beam printer) A, information light modulated in accordance with image information is projected from a scanner portion 3 onto an electrophotographic photosensitive member in the form of a drum so that and electrostatic latent image is formed on the photosensitive member, and the latent image is developed into a toner image. In synchronism with formation of the toner image, a transfer material P (recording material) is fed in seriatim out of a sheet cassette 5a by a corporation of a sheet feeding roller 5b and a separation claw 5c press-contacted to the top surface of the recording materials to the corner portions. The transfer material P is fed by feeding means 5 including a guiding plate 5d and registration rollers 5e and so on. The toner image formed on the electrophotographic photosensitive member in a process cartridge B is transferred onto the transfer material by voltage application to the transferring means in the form of a transfer roller 6, and the transfer material is fed to a fixing portion 7 along a feeding path 5h. The fixing portion 7 comprises a pressing roller 7b and a fixing roller 7a containing therein a heater 7c, and applies heat and pressure to the recording material passing through a nip formed therebetween surface to fix the transferred toner image. The recording material is discharged by discharging rollers 5f to a discharging portion 8 through a reverse feeding path.

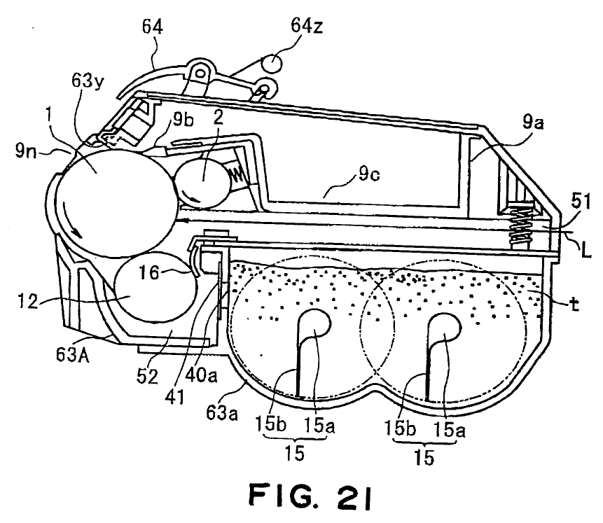

On the other hand, the process cartridge B contains the electrophotographic photosensitive member and at least one process means. Here, the process means includes charging means for electrically charging the electrophotographic photosensitive member, developing means for developing a latent image formed on the electrophotographic photosensitive member, cleaning means for removing the toner remaining on a surface of the electrophotographic photosensitive member, for example. As shown in FIG. 21, in the process cartridge B of this embodiment, the electrophotographic photosensitive member in the form of a photosensitive drum 1 having a photosensitive layer is rotated, during which the charging means 2 in the form of a charging roller is supplied with a charging voltage to uniformly charge the surface of the photosensitive drum 1. The light image is projected from the scanner portion 3 onto the charged surface of the photosensitive drum 1 through an exposure opening 51, so that latent image is formed. Then, the latent image is developed by a developing zone 52 (developing means).

In the developing zone 52, the toner is fed out of the toner container 63a through the opening 40a by a toner feeding mechanism 15 (toner feeding means) which is rotatable and provided in a toner accommodating portion. A developing roller 12 (developing member) enclosing a fixed magnet is rotated by which a layer of toner triboelectrically charged by a developing blade 16 is formed on the surface of the developing roller 12. The toner in the toner layer is transferred onto the photosensitive drum 1 in accordance with the latent image so that visualized toner image is formed. The toner feeding mechanism 15 comprises a shaft 15a and a stirring blade 15b. The shaft 15a is rotatably supported on the toner container 63a, and one and thereof is extended out of the container 63a. Indicates that process cartridge B is a fresh one, the opening 40a is sealed with a toner seal member 41, and the toner does not leak out from the toner container 63a. The toner seal member 41 is removed by an automatic unsealing mechanism.

After the toner image is transferred onto the recording material by the application of a voltage of the polarity opposite from that of the toner image to the transfer roller 6, the residual toner remaining on the photosensitive drum 1 is scrapped off by a cleaning blade 9b, and the removed toner is received by a receptor sheet 63y and is collected into a removed toner accommodating portion 9c of the cleaner container 9a. Thus, the residual toner is removed from the photosensitive drum 1 by the cleaning means.

### Cartridge Mounting Mean)

The photosensitive drum 1 and so on are contained as a unit in a cartridge frame comprising a toner container 63a and a cleaner container 9a, and are mounted as a unit to the main assembly 30B of the cartridge.

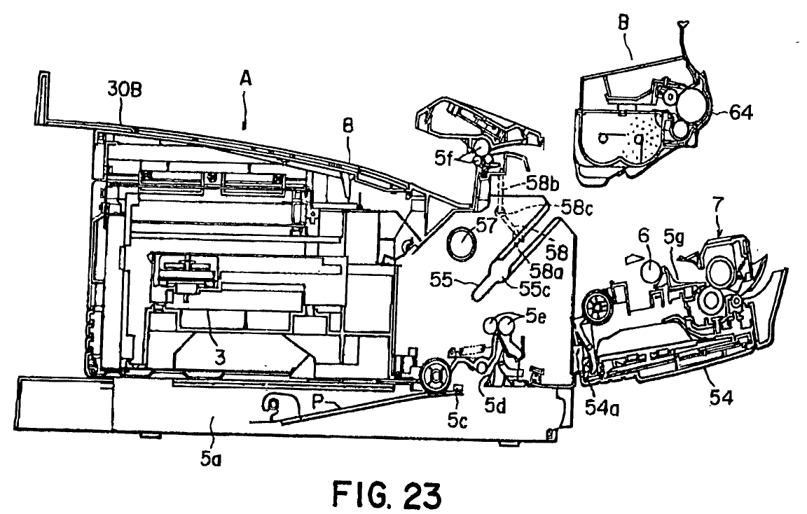

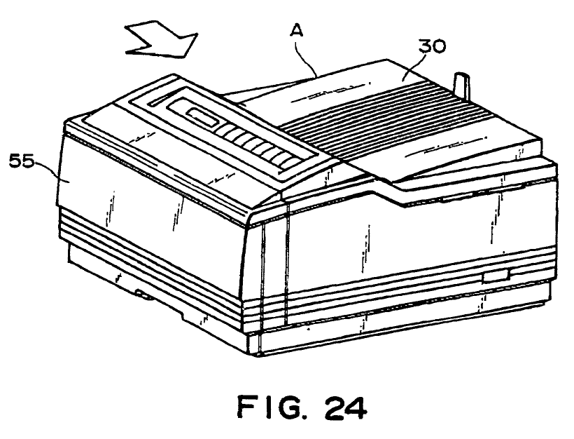

When an opening and closing member 54 is rotated about a shaft 53a (FIGS. 22, 23), cartridge mounting means can be seen as shown in FIG. 23. It comprises guide grooves 55 which are provided on opposite side walls (left and right) in the cartridge mounting space so to be symmetrically opposed to each other. The guide groove 55 extend downward to the front. The guide groove 55 is substantially linear. The inlet portion of the guide groove 55 is provided with a main assembly side positioning portion 55c.

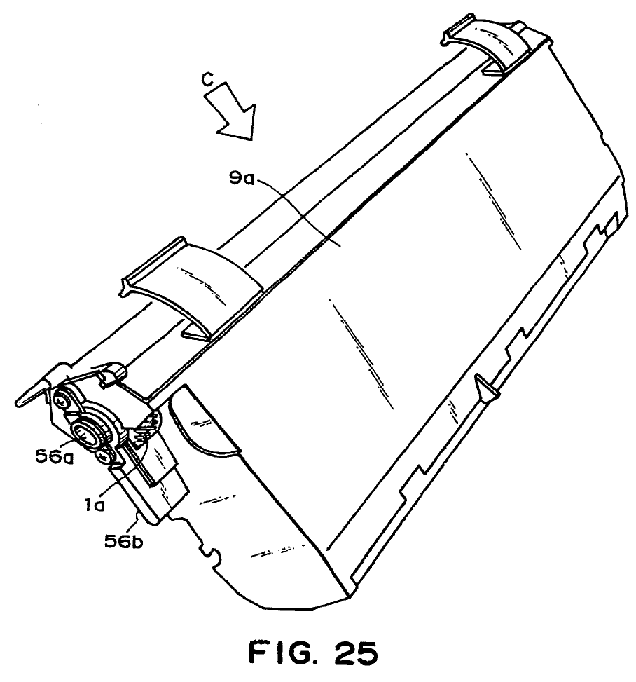

On the other hand, the process cartridge B is provided on opposite lateral sides with guide portions corresponding to the guide groove 55. The guide portions are projected from symmetrical positions of the cartridge frame. As shown in FIG. 25, it comprises integral boss 56a end rib 56b. The boss 56a and the rib 56b are integrally formed on the cleaner container 9a to which the photosensitive drum 1 is mounted. The boss 56a is disposed on an extension of a rotation shaft of the photosensitive drum 1, and the rib 56b is continuously extended from the boss 56a toward downstream with respect to the inserting direction of the process cartridge B indicated by arrow C in FIG. 25. It is extended downward to the downstream direction into conformity with the guide groove 55.

With the structure, when the process cartridge B is mounted to the main assembly of the image forming apparatus, the opening and closing member 54 is opened, and the process cartridge B is inserted into the main assembly 30B of the apparatus so as to engage the rib 56b in the guide groove 55. Then, the boss 56a of the process cartridge B is seated on the main assembly positioning portion 55c to the inlet portions of the guide groove 55. By doing so, the drum gear 1a fixed to the photosensitive drum 1 at the end portion (FIG. 25) is brought into meshing engagement with the driving gear 57 of the main assembly 30B of the apparatus (FIG. 23), so that tribe transmission connection is established between the main assembly and the process cartridge B. The drum gear 1a is engaged with the developing roller gear A12c at all times (Embodiment 1).

When the opening and closing member 54 is closed, a shutter opening lever 58 which is interrelated with the opening and closing member 54 is rotated in the counterclockwise direction from a position 58a to a position 58b about the shaft 58c. By this, the shutter 64 is moved against an unshown spring force of a torsion coil spring to open the transfer opening 9n, the coil spring being engaged with a pin 64z of the shutter 64 and urging the shutter 64 about am unshown pin mounted on the cleaner container 9a in the direction of closing the transfer opening 9n.

When the process cartridge 8 is taken out, the opening and closing member 54 is opened, the shutter opening lever 58 is rotated about the shaft 58c and is returned from the position 58b to the position 58a. Then, the shutter 64 is rotated by the unshown spring force of the torsion coil spring about the unshown pin to close the transfer opening 9n. Then, the process cartridge B is lifted so that boss 56a is away from the main assembly positioning portion 55c, and thereafter, the process cartridge B is lifted in the inclined direction so that rib 56b is guided along the guide groove 55. Thus, the process cartridge B is taken out.

### Automatic Unsealing Mechanism

The automatic toner seal removing mechanism (toner opening unsealing mechanism) is similar to that of Embodiment 1, and therefore, the detailed description thereof is omitted for simplicity.

The difference from Embodiment 1 is that driving gear 57 which is a drum gear coaxially fixed to the photosensitive drum 1 is engaged with the developing roller gear A12a at all times.

According to the embodiments of the present invention, it is not until the process cartridge is inserted into the main assembly of the image forming apparatus that drive transmission from the main assembly of the apparatus is enabled. The seal member is not unintentionally wound up even if the driving means is actuated during the inspecting operation in the manufacturing. The driving is automatically stopped when the winding-up shaft is rotated through a predetermined number of turns, and therefore, after the sealing member is wound up to the satisfactory extent, the driving power can be saved, and the toner scattering, noise or the like due to the flappering of the seal member can be avoided.

While the invention has been described with reference to the structures disclosed herein, it is not confined to the details set forth and this application is intended to cover such modifications or changes as may come within the purpose of the improvements or the scope of the following claims.

What is claimed is:

1. A process cartridge detachably mountable to a main assembly of an image forming apparatus, comprising:
an electrophotographic photosensitive member;
developing means for developing an electrostatic latent image formed on said electrophotographic photosensitive member with a developer;
a developer container for containing the developer, said developer container having an opening for supplying the developer to said developing means;
a sealing member for sealing the opening of said developer container;
a winding shaft for winding said sealing member, said sealing member being rotatably supported by said developer container;
driving means for applying a driving force to rotate said winding shaft; and
drive control means for permitting and preventing transmission of the driving force to said winding shaft, wherein said driving control means permits the transmission in response to insertion of said process cartridge into the main assembly of the image forming apparatus and prevents transmission in response to a predetermined number of rotations of said winding shaft.

2. A process cartridge according to claim 1, wherein said driving means applies the driving force from the main assembly of the apparatus.

3. A process cartridge according to claim 1 or 2, wherein said driving control means includes a swingable gear which in swingable between a first position for permitting the transmission of the driving force to said winding shaft and a second position for preventing the transmission of driving force to said winding shaft.

4. A process cartridge according to claim 1, 2 or 3, wherein said driving control means includes a sliding gear movable between a disengaging position which is taken when said process cartridge is not inserted into the main assembly of the apparatus and an engaging petition which is taken when said process cartridge is inserted into the main assembly of the apparatus.

5. A process cartridge according to any one of claims 1-4, wherein said driving control means includes cam portion having a predetermined cam profile, lever portion abutted to the cam portion to move the swingable gear from a first position to a second position, and a Geneva gear mechanism integral with said cam portion to stop rotation of the cam portion at the second position and to maintain the second position.

6. An electrophotographic image forming apparatus for forming an image on a recording material, to which a process cartridge is detachably mountable, said apparatus comprising:
a mounting means for detachably mounting the process cartridge, the process cartridge including:
an electrophotographic photosensitive member;
developing means for developing an electrostatic latent image formed on said electrophotographic photosensitive member with a developer;
a developer container for containing the developer, said developer container having an opening for supplying the developer to said developing means;
a sealing member for sealing the opening of said developer container;
a winding shaft for winding said sealing member, said sealing member being rotatably supported by said developer container;
driving means for applying a driving force to rotate said winding shaft; and
drive control means for permitting and preventing transmission of the driving force to said winding shaft, wherein said driving control means permits the transmission in response to insertion of said process cartridge into the main assembly of the image forming apparatus ad prevents transmission in response to a predetermined number of rotations of said winding shaft;
b. feeding means for feeding the recording material; and
c. driving means for driving said driving means of said process cartridge.

7. A process cartridge detachably mountable to a main assembly of an image forming apparatus, comprising:
developing means for developing an electrostatic latent image formed on and electrophotographic photosensitive member with a developer;
a developer container for containing the developer, said developer container having an opening for supplying the developer to said developing means;
a sealing member for sealing the opening of said developer container;
a winding shaft for winding said sealing member, said sealing member being rotatably supported by said developer container;
driving means for applying a driving force to rotate said winding shaft; and
drive control means for permitting and preventing transmission of the driving force to said winding shaft, wherein said driving control means permits the transmission in response to insertion of said developing cartridge into the main assembly of the image forming apparatus and prevents transmission in response to a predetermined number of rotations of said winding shaft.

8. A developing cartridge according to claim 7, wherein said driving control means includes a swingable gear which is swingable between a first position for permitting the transmission of the driving force to said winding shaft and a second position for preventing the transmission of driving force to said winding shaft.

9. A developing cartridge according to claim 7 or 8, wherein said driving control means includes cam portion having a predetermined cam profile, lever portion abutted to the cam portion to move the swingable gear from a first position to a second position, and a Geneva gear mechanism integral with said cam portion to stop rotation of the cam portion at the second position and to maintain the second position.

10. A developing cartridge according to any one of claim 7-9, wherein said driving control means includes cam portion having a predetermined cam profile, lever portion abutted to the cam portion to move the swingable gear from a first position to a second position, and a Geneva gear mechanism integral with said cam portion to stop rotation of the cam portion at the second position and to maintain the second position.

11. An electrophotographic image forming apparatus for forming an image on a recording material, to which a developing cartridge is detachably mountable, comprising:
a. mounting means for detachably mounting the process cartridge, the process cartridge including,
developing means for developing a latent image formed on an electrophotographic photosensitive member with a developer;
a developer container for containing the developer, said developer container having an opening for supplying the developer to said developing means;
a sealing member for sealing the opening of said developer container;
a winding shaft for winding said sealing member, said sealing member being rotatably supported by said developer container;
driving means for applying a driving force to rotate said winding shaft; and
drive control means for permitting and preventing transmission of the driving force to said winding shaft, wherein said driving control means permits the transmission in response to insertion of said developing cartridge into the main assembly of the image forming apparatus and prevents transmission in response to a predetermined number of rotations of said winding shaft;
b. feeding means for feeding the recording material; and
c. driving means for driving said driving means of said process cartridge.
